(19) United States
(12) Patent Application Publication
(10) Pub. No.: US 2026/0163034 A1
(43) Pub. Date: Jun. 11, 2026

(54) FUEL CELL SYSTEM

(71) Applicant: Honda Motor Co., Ltd., Tokyo (JP)

(72) Inventor: Yuuki Sakamoto, Saitama (JP)

(21) Appl. No.: 19/403,917

(22) Filed: Nov. 30, 2025

(30) Foreign Application Priority Data
Dec. 6, 2024 (JP) 2024-213093

(51) Int. Cl. H01M 8/04746; H01M 8/04082; H01M 8/04302; H01M 8/04828

(52) U.S. Cl. CPC H01M 8/04753; H01M 8/04201; H01M 8/04302; H01M 8/04835

(57) ABSTRACT

A fuel cell system including a fuel cell stack configured to generate electric power using an anode gas and a cathode gas includes: a microprocessor configured to perform a series of power generation controls including an activation control based on an activation instruction, a normal power generation control based on a power generation target, and a stop control based on a stop instruction; and a normally-closed control valve including a movable valve body that abuts a seal member of a valve seat portion in a closed state. When the microprocessor determines that the control valve has not been opened before the stop control in the series of power generation controls, the microprocessor performs, in the stop control, a forced valve-opening process for opening the control valve.

### CROSS-REFERENCE TO RELATED APPLICATION

This application is based upon and claims the benefit of priority from Japanese Patent Application No. 2024-213093 filed on Dec. 6, 2024, the content of which is incorporated herein by reference.

### BACKGROUND OF THE INVENTION

### Field of the Invention

The present invention relates to a fuel cell system.

### Description of the Related Art

A technique is known in which a bypass flow path for bypassing a humidifier provided on a cathode flow path that supplies a cathode gas to a fuel cell stack is provided, and a bypass flow rate control valve (a humidifier bypass valve) provided on the bypass flow path is opened to conduct dry control so as to supply dry air to the fuel cell stack at the time of activation at a low temperature (see JP 2017-152113 A).

In recent years, in order to ensure an access to sustainable and advanced energy, technologies related to fuel cells that contribute to energy efficiency have been developed.

In the related art, in a case where the humidifier bypass valve has not been open for a long period of time, the humidifier bypass valve may stick in a closed state.

### SUMMARY OF THE INVENTION

An aspect of the present invention is a fuel cell system including a fuel cell stack configured to generate electric power using an anode gas and a cathode gas. The fuel cell system included: a microprocessor configured to perform a series of power generation control including at least an activation control based on an activation instruction, a normal power generation control based on a power generation target, and a stop control based on a stop instruction; a memory connected to the microprocessor; and a normally-closed control valve including a movable valve body that, in a valve-closed state, abuts a seal member of a valve seat portion. The memory stores valve opening information indicating that the control valve has been opened under a predetermined condition. The microprocessor determines, based on the valve opening information, whether the control valve has been opened before the stop control in the series of power generation control. When determining that the control valve has not been opened, the microprocessor performs, in the stop control, a forced valve opening processing for opening the control valve.

### BRIEF DESCRIPTION OF THE DRAWINGS

The objects, features, and advantages of the present invention will become clearer from the following description of embodiments in relation to the attached drawings, in which:

FIG. 1 is a schematic configuration diagram of a fuel cell system according to an embodiment of the present invention;

FIG. 2 is a diagram illustrating an outline of power generation control of the fuel cell system;

FIG. 3 is a diagram for describing a flow of stop processing;

FIG. 4A is a flowchart illustrating an example of a series of power generation control processing performed by a controller;

FIG. 4B is a flowchart describing details of stop control;

FIG. 5A is a cross-sectional view illustrating a humidifier bypass valve; and

FIG. 5B is a perspective view for describing main components of the humidifier bypass valve.

### DETAILED DESCRIPTION OF THE INVENTION

Hereinafter, embodiments of the invention will be described below with reference to the drawings.

### Configuration of Fuel Cell System

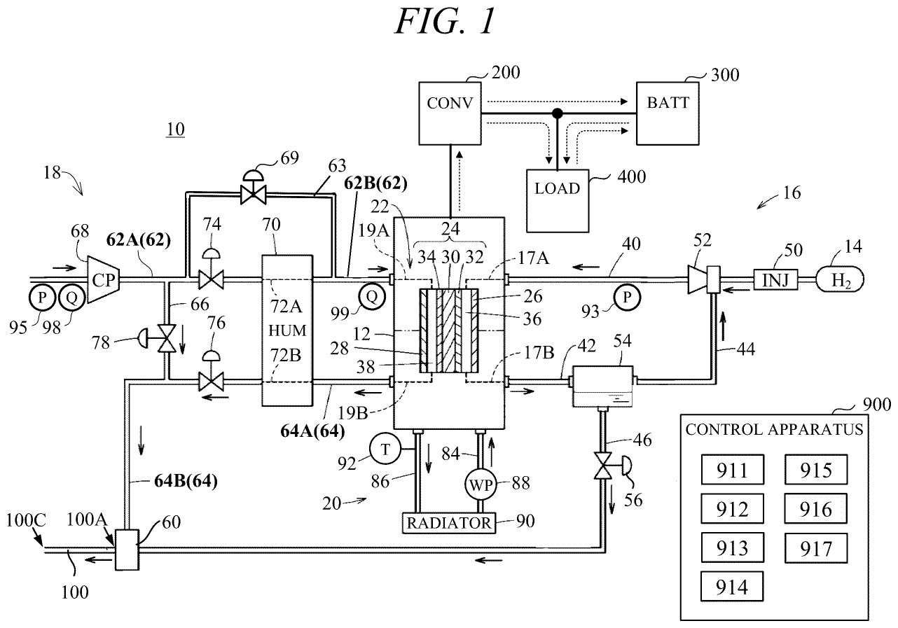

FIG. 1 is a schematic configuration diagram of a fuel cell system 10 according to the present invention. The fuel cell system 10 is mounted on a vehicle (a fuel cell vehicle). Alternatively, the fuel cell system 10 may be mounted on a ship, an aircraft, a robot, or the like.

The fuel cell system 10 includes a fuel cell stack 12, a hydrogen tank 14, an anode system 16, a cathode system 18, a cooling system 20, and a control device 900. Output (power) of the fuel cell stack 12 is boosted to a necessary voltage by a voltage converter 200, and is supplied to a battery 300 as a secondary battery or is supplied to a load 400 such as a motor.

The battery 300 is made up of, for example, a lithium ion battery. According to an embodiment, as an example, regenerative power from the load 400 and FC power obtained by the power generation operation of the fuel cell stack 12 are stored (charged) in the battery 300, and are then discharged from the battery 300 for allowing the fuel cell vehicle to travel and operating a predetermined auxiliary machine.

The fuel cell stack 12 includes a plurality of power generation cells 22, which are stacked in one direction. Each power generation cell 22 has an electrolyte membrane and electrode structure 24 (also simply referred to as an electrode structure 24) and a pair of separators 26 and 28. The pair of separators 26 and 28 sandwich the electrode structure 24.

The electrode structure 24 includes a solid polymer electrolyte membrane (also simply referred to as an electrolyte membrane 30), an anode electrode 32, and a cathode electrode 34. The electrolyte membrane 30 is, for example, a thin film of perfluorosulfonic acid containing moisture. The anode electrode 32 and the cathode electrode 34 sandwich the electrolyte membrane 30. The anode electrode 32 and the cathode electrode 34 each have a gas diffusion layer made of carbon paper or the like. Porous carbon particles are uniformly applied to the surface of the gas diffusion layer to form an electrode catalyst layer. A platinum alloy is supported on the surface of the porous carbon particles. The electrode catalyst layer is formed on each of both surfaces of the electrolyte membrane 30.

An anode flow path 36 is formed on a surface facing the electrode structure 24 among the surfaces of the separator 26. The anode flow path 36 is connected with an anode supply flow path 40 through an anode inlet 17A. The anode flow path 36 is connected with an anode discharge flow path 42 via an anode outlet 17B. A cathode flow path 38 is formed on a surface facing the electrode structure 24 among the surfaces of the separator 28. The cathode flow path 38 is connected with a cathode supply flow path 62 through a cathode inlet 19A. The cathode flow path 38 is connected with a cathode discharge flow path 64 through a cathode outlet 19B.

Note that the supply flow path may be referred to as a supply path. The discharge flow path may be referred to as a discharge path.

An anode gas (hydrogen) is supplied to the anode electrode 32. In the anode electrode 32, hydrogen ions and electrons are generated from hydrogen molecules in accordance with an electrode reaction by a catalyst. The hydrogen ions permeate through the electrolyte membrane 30, and move to the cathode electrode 34. The electrons move sequentially in the order of the anode electrode 32, a negative electrode terminal (not illustrated) of the fuel cell stack 12, the voltage converter 200, a positive electrode terminal (not illustrated) of the fuel cell stack 12, and the cathode electrode 34. In the cathode electrode 34, hydrogen ions and electrons react with oxygen contained in the supplied air in accordance with the action of the catalyst, and water is produced.

The anode system 16 includes each component for supplying an anode gas to the anode electrode 32 and each component for discharging an anode off-gas from the anode electrode 32. The anode system 16 includes an anode supply flow path 40, an anode discharge flow path 42, a circulation flow path 44, and a drain flow path 46. The anode system 16 also includes an injector 50, an ejector 52, a gas-liquid separator 54, and a drain valve 56.

Note that the anode discharge flow path 42 and the drain flow path 46 will be collectively referred to as an anode discharge flow path, in some cases.

The anode supply flow path 40 communicates between the discharge port of the hydrogen tank 14 and the anode inlet 17A. The injector 50, the ejector 52, and a pressure sensor 93 are provided on the anode supply flow path 40. The ejector 52 is disposed to be closer to the anode inlet 17A than the injector 50. The pressure sensor 93 is disposed to be closer to the anode inlet 17A than the ejector 52. The pressure sensor 93 detects the pressure of the anode gas, and sends a detection signal to the control device 900.

The anode discharge flow path 42 communicates between the anode outlet 17B and an intake port of the gas-liquid separator 54. The circulation flow path 44 communicates between an exhaust port of the gas-liquid separator 54 and the ejector 52. The drain flow path 46 communicates between a drain port of the gas-liquid separator 54 and an inlet of a dilutor 60. The drain valve 56 is provided on the drain flow path 46.

The cathode system 18 includes each component for supplying a cathode gas to the cathode electrode 34 and each component for discharging a cathode off-gas from the cathode electrode 34. The cathode system 18 includes the cathode supply flow path 62, the cathode discharge flow path 64, and a cathode bypass flow path 66. The cathode system 18 also includes a compressor 68 as a cathode gas supply device, a humidifier 70, a sealing valve (In) 74, a sealing valve (Out) 76, a cathode bypass valve 78, and a humidifier bypass valve 69. The cathode system 18 further includes a humidifier bypass flow path 63, which bypasses the humidifier 70, and which serves as part of the cathode supply flow path 62.

Note that the cathode bypass flow path may be referred to as a cathode bypass path, and the humidifier bypass flow path may be referred to as a humidifier bypass path. In addition, the humidifier bypass valve 69 will be referred to as a control valve, in some cases.

The fuel cell system 10 according to an embodiment performs forced valve opening processing for the purpose of preventing sticking of the humidifier bypass valve 69 as a control valve, as will be described later in detail.

The cathode supply flow path 62 communicates between an air intake port (not illustrated) and the cathode inlet 19A. The compressor 68, the sealing valve (In) 74, and a flow path 72A of the humidifier 70 are provided on the cathode supply flow path 62. A cathode supply flow path 62A denotes an upstream portion, further upstream than the humidifier 70, of the cathode supply flow path 62. A cathode supply flow path 62B denotes a downstream portion, further downstream than the humidifier 70, of the cathode supply flow path 62. A pressure sensor 95, an air flow sensor 98, the compressor 68, and the sealing valve (In) 74 are provided on the cathode supply flow path 62A. The sealing valve (In) 74 is disposed to be closer to the humidifier 70 than the compressor 68. The pressure sensor 95 and the air flow sensor 98 are disposed to be closer to the air intake port (not illustrated) than the compressor 68. The pressure sensor 95 detects the pressure of the sucked air (atmosphere), and sends a detection signal to the control device 900. The pressure sensor 95 also functions as an atmospheric pressure sensor outside the vehicle. The air flow sensor 98 detects a supply flow rate of the cathode gas (may be referred to as a compressor supply flow rate), and sends a detection signal to the control device 900.

An air flow sensor 99 is provided on the cathode supply flow path 62B. The air flow sensor 99 detects a flow rate of the cathode gas supplied to the fuel cell stack 12 (may be referred to as a stack supply flow rate), and sends a detection signal to the control device 900. The stack supply flow rate corresponds to a flow rate (may be referred to as a cathode bypass flow rate) obtained by subtracting a flow rate of the cathode gas flowing through the bypass flow path 66 from the compressor supply flow rate.

The humidifier 70 recovers moisture contained in the cathode off-gas flowing through the flow path 72B, and adds the recovered moisture to the cathode gas flowing through the flow path 72A. The purpose of humidifying the cathode gas flowing through the flow path 72A is to prevent excessive drying of the electrode structure 24.

The humidifier bypass flow path 63 communicates between the cathode supply flow path 62A and the cathode supply flow path 62B. According to an embodiment, a portion, between the compressor 68 and the sealing valve (In) 74, of the cathode supply flow path 62A communicates with a portion, further upstream than the air flow sensor 99, of the cathode supply flow path 62B. The humidifier bypass valve 69 is provided on the humidifier bypass flow path 63.

### Humidifier Bypass Valve

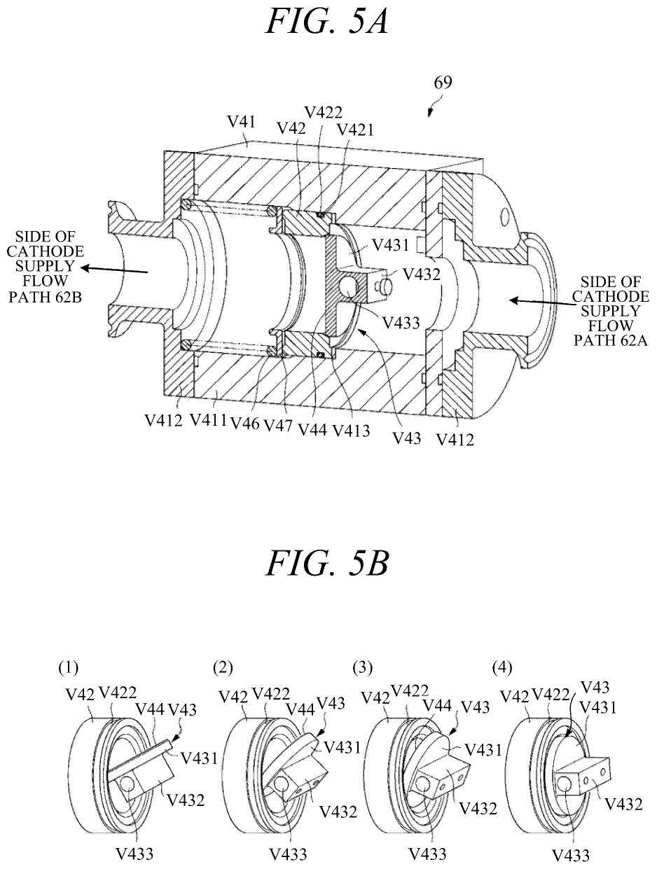

A configuration example of the humidifier bypass valve 69 will be described with reference to FIGS. 5A and 5B.

FIG. 5A is a cross-sectional view illustrating the humidifier bypass valve 69, which is provided on the humidifier bypass flow path 63. In addition, FIG. 5B is a perspective view for describing main components of the humidifier bypass valve 69. As an example, the humidifier bypass valve 69 is configured with a butterfly valve of normally closed type.

In FIGS. 5A and 5B, the humidifier bypass valve 69 includes: a housing V41 having a cylindrical shape; a valve seat portion V42, which has an annular shape, and which is provided along an inner wall surface of the housing V41; a valve body V43 having a disk shape; a shaft (not illustrated) which penetrates through the valve body V43, and which axially supports the valve body V43 to be rotatable; and a spring V46, which is provided inside the housing V41, and which holds the valve seat portion V42.

The housing V41 includes: a housing body V411, which has a cylindrical shape; and joints V412, which are provided on both ends of the housing body V411.

A step V413 is formed along the circumferential direction on an inner wall surface of the housing body V411, and an inner diameter closer to one end (on the left in FIG. 5A) than the step V413 of the housing V41 is larger than an inner diameter on the other end (on the right in FIG. 5A).

The valve seat portion V42 is fit to an inner wall surface closer to such one end than the step V413 of the housing V41.

A recess portion V422, which extends along the circumferential direction, is formed on an outer circumferential surface of the valve seat portion V42, and a rubber ring V421 for holding the valve seat portion V42 is provided in the recess portion V422. That is, the rubber ring V421 is provided on the inner wall surface of the housing V41.

The valve body V43 includes: a main body V431, which has a disk shape; and a shaft penetration portion V432, which is provided on one end (on the right in FIG. 5A) of the main body V431, and in which a through hole V433 through which the shaft (not illustrated) penetrates.

The valve body V43 is disposed so that the surface at an opposite end of the shaft penetration portion V432 is directed toward the cathode supply flow path 62B. A circumferential edge, which is closer to the cathode supply flow path 62B, of the main body V431 of the valve body V43 serves as a valve seal surface V44.

One of the valve seat portion V42 and the valve body V43 is made of stainless steel or a non-ferrous metal, and the other one of them is made of a resin or a rubber material (an elastic material). According to an embodiment, the valve seat portion V42 is made of an elastic material, and thus the valve seat portion V42 itself is made to function as a seal member.

A shaft (not illustrated), which penetrates through the through hole V433 of the valve body V43, is rotatably supported by a bearing (not illustrated) provided on the housing V41. When rotation of such a shaft is driven by a drive mechanism, not illustrated, the valve body V43 rotates together with the shaft.

The spring V46 is provided to be closer to one end (on the left in FIG. 5A) than the step V413 of the housing V41. The spring V46 biases the valve seat portion V42 toward the step V413 via a support portion V47 having an annular shape.

The humidifier bypass valve 69, which has been described above operates as follows.

As illustrated in (1) to (4) of FIG. 5B, the valve body V43 as a movable portion rotates and the extending direction of the valve body V43 becomes substantially perpendicular to the extending direction of the housing V41, the valve seal surface V44 of the valve body V43 is seated on the valve seat portion V42, which has an annular shape, and which serves as the valve seat, and then the humidifier bypass valve 69 is closed. A valve closed state is illustrated in (4) of FIG. 5B.

In the valve closed state, the rubber ring V421 aligns the valve body V43. In addition, the valve seat portion V42 is biased toward the valve body V43 by the spring V46.

On the other hand, the valve body V43 rotates and the extending direction of the valve body V43 becomes almost parallel to the extending direction of the housing V41, the circumferential edge portion of the valve body V43 is separated from the valve seat portion V42, and then the humidifier bypass valve 69 is opened. Intermediate opening degrees between a fully open state and a fully closed state are illustrated in (1) to (3) of FIG. 5B, and magnitudes of the opening degrees satisfy (1)>(2)>(3).

Returning to FIG. 1, the cathode discharge flow path 64 communicates between the cathode outlet 19B and an inlet of the dilutor 60. A flow path 72B of the humidifier 70 and the sealing valve (Out) 76 are provided on the cathode discharge flow path 64. A cathode discharge flow path 64A denotes an upstream portion, further upstream than the humidifier 70, of the cathode discharge flow path 64. A cathode discharge flow path 64B denotes a downstream portion, further downstream than the humidifier 70, of the cathode supply flow path 62. The sealing valve (Out) 76 is provided on the cathode discharge flow path 64B.

A discharge pipe 100 is constituted of, for example, a hollow pipe having a length of about one meter. An inlet 100A of the discharge pipe 100 is connected with an outlet of the dilutor 60. An outlet 100C of the discharge pipe 100 is located, for example, under the floor of a substantially central portion of the vehicle. The provision of the discharge pipe 100 discharges the gas (a combined gas in which the cathode off-gas that has flowed through the cathode discharge flow path 64B and the anode off-gas that has flowed through the anode discharge flow path 42 and the drain flow path 46 are combined together) that has been diluted by the dilutor 60 to the outside (into the atmosphere) in a space away from the user in the vehicle.

The cathode bypass flow path 66 communicates between the cathode supply flow path 62A and the cathode discharge flow path 64B. For example, the cathode bypass flow path 66 communicates between a portion between the compressor 68 and the sealing valve (In) 74 on the cathode supply flow path 62A and a downstream portion of the sealing valve (Out) 76 on the cathode discharge flow path 64B. The cathode bypass valve 78 is provided on the cathode bypass flow path 66.

The cooling system 20 includes each component for supplying a refrigerant to the fuel cell stack 12 and each component for discharging the refrigerant from the fuel cell stack 12. The cooling system 20 includes a refrigerant supply flow path 84 and a refrigerant discharge flow path 86. The cooling system 20 also includes a refrigerant pump 88, a radiator 90, and a temperature sensor 92.

A refrigerant flow path (not illustrated) for cooling the fuel cell stack 12 is formed inside the fuel cell stack 12. The refrigerant supply flow path 84 communicates between an outlet of the radiator 90 and an inlet of the refrigerant flow path. The refrigerant pump 88 is provided on the refrigerant supply flow path 84. The refrigerant discharge flow path 86 communicates between an outlet of the refrigerant flow path and an inlet of the radiator 90. The temperature sensor 92 is provided on the refrigerant discharge flow path 86. The temperature sensor 92 detects the temperature of the refrigerant discharged from the fuel cell stack 12, and sends a detection signal to the control device 900.

The control device 900 is a computer (for example, an ECU of the vehicle). The control device 900 includes a controller 911, a storage 912, a system activation controller 913, a standby power generation controller 914, a normal power generation controller 915, a stop-time power generation controller 916, and a stop controller 917.

The controller 911 includes a processing circuit. The processing circuit may be a processor such as a CPU. The processing circuit may be an integrated circuit such as an ASIC or an FPGA. By executing a program stored in the storage 912, the processor is capable of performing various types of processing. At least some of a plurality of types of processing may be performed by an electronic circuit including a discrete device.

The storage 912 includes a volatile memory and a nonvolatile memory. Examples of the volatile memory include a RAM. The volatile memory is used as a working memory of the processor. The volatile memory temporarily stores data or the like necessary for processing or operation. Examples of the nonvolatile memory include a ROM, and a flash memory. The nonvolatile memory is used as a memory for storing data. The nonvolatile memory stores programs, tables, maps, and the like. At least a part of the storage 912 may be provided in the processor, the integrated circuit, or the like, as described above.

The storage 912 may be used as a storage device that stores valve opening information to be described later. The valve opening information denotes information indicating that the humidifier bypass valve 69 is opened in a series of power generation control. According to an embodiment, when the humidifier bypass valve 69 is opened before stop processing, the valve opening information is recorded in the storage 912. The humidifier bypass valve 69 is opened only when warm-up power generation is conducted.

For example, the controller 911 receives detection signals from various sensors provided in the fuel cell system 10. The controller 911 outputs a control signal for controlling each valve, the injector 50, the compressor 68, the refrigerant pump 88, or the like, based on an instruction from a control unit, not illustrated, and each detection signal. Accordingly, power generation control for the fuel cell system 10 is conducted. The controller 911 may cause the system activation controller 913, the standby power generation controller 914, the normal power generation controller 915, the stop-time power generation controller 916, and the stop controller 917 to share the control. In this case, each valve, the injector 50, the compressor 68, the refrigerant pump 88, and the like operate in accordance with a control signal from the controller 911 or each controller.

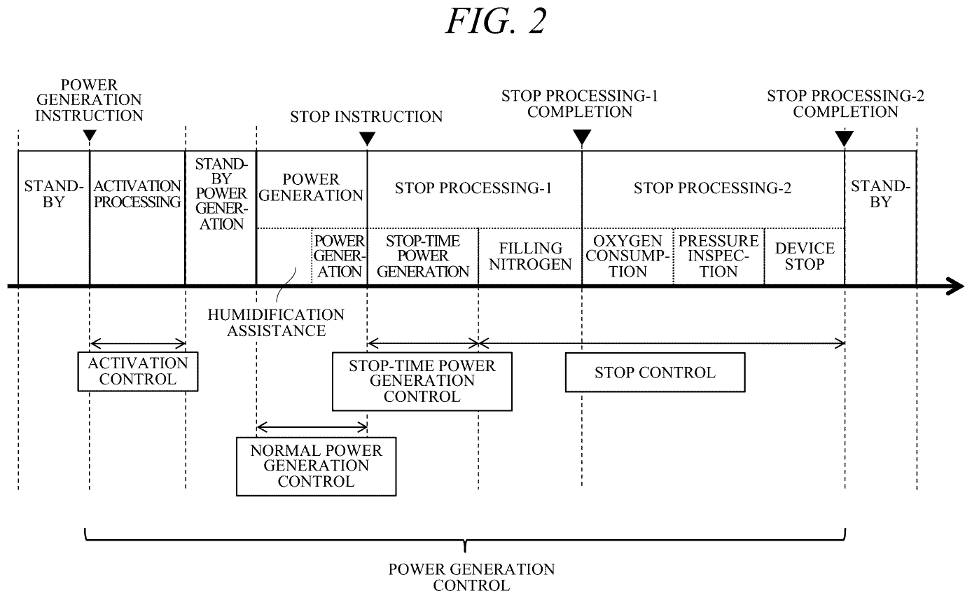

FIG. 2 is a diagram illustrating an outline of power generation control of the fuel cell system 10. Along a time axis indicated by an arrow from the left to the right in FIG. 2, the controller 911 or each controller conducts a series of power generation control including activation control for activating the fuel cell system 10 in a standby state, normal power generation control for causing the fuel cell system 10 to generate electric power, and stop control for stopping the fuel cell system 10 to be brought into the standby state. The series of power generation control may be referred to as a driving cycle of the fuel cell system 10.

### Activation Control

Upon receipt of a power generation instruction (may be referred to as an activation instruction) from a control unit, not illustrated, the controller 911 causes the system activation controller 913 to conduct the activation control on the fuel cell system 10 in the standby state. The standby state denotes a state in which an instruction to the fuel cell system 10 is acceptable.

### Warm-Up Power Generation Control

In a case where the stack temperature detected by the temperature sensor 92 at the time of the power generation instruction is lower than a predetermined first temperature, the controller 911 causes the standby power generation controller 914 to conduct the standby power generation control for causing the fuel cell system 10 to perform the warm-up power generation. The first temperature corresponds to a temperature at which the refrigerant may be frozen. The warm-up power generation denotes, for example, power generation of relatively reducing the supply flow rate of the cathode gas with respect to the anode gas to perform low-efficiency power generation, and increasing the amount of heat generated in the fuel cell stack 12 as compared with that in the normal power generation. According to an embodiment, the standby power generation and the warm-up power generation have the same meaning. The warm-up power generation may be simply referred to as warm-up.

In addition, when the stack temperature reaches a predetermined second temperature higher than the above first temperature, or when a predetermined time has elapsed since the warm-up power generation was started, the standby power generation controller 914 determines that the warm-up is completed. The second temperature corresponds to a temperature at which the stack temperature is sufficiently increased.

When the stack temperature reaches the predetermined second temperature higher than the above first temperature, the humidifier bypass valve 69 is opened to supply the cathode gas, which is not humidified by the humidifier 70, to the fuel cell stack 12 and dry the fuel cell stack 12.

### Normal Power Generation Control

The controller 911 causes the normal power generation controller 915 to conduct the normal power generation control for causing the fuel cell system 10 to perform normal power generation, based on a power generation target from a control unit, not illustrated. By adjusting the opening degree of the humidifier bypass valve 69, based on, for example, the stack temperature that has been detected by the temperature sensor 92 during the power generation, the normal power generation controller 915 may prevent excessive drying of the electrode structure 24 (humidification assistance).

### Stop Control

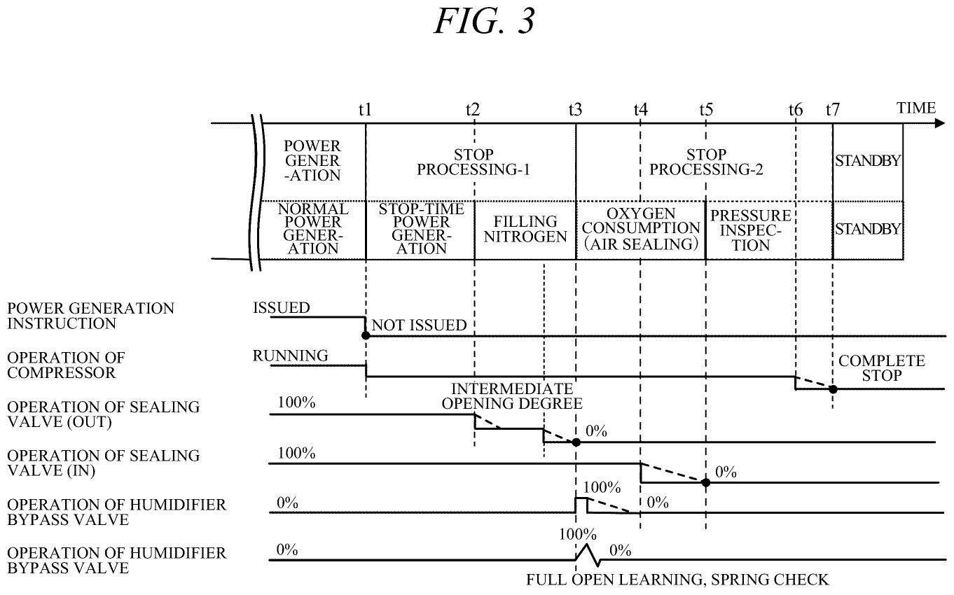

Upon receipt of a stop instruction from a control unit, not illustrated, the controller 911 causes the stop controller 917 to conduct stop control on the fuel cell system 10. FIG. 3 is a time chart illustrating a flow of stop processing. The stop processing includes a stop process-1 and a stop process-2.

When a stop instruction is issued at time t1 in FIG. 3, the stop controller 917 starts the stop process-1. When the stop process-1 is started, the number of rotations of the compressor 68 is reduced as compared with that in the normal power generation, and the total air amount of the cathode gas discharged from the compressor 68 is reduced.

### Stop-Time Power Generation Control

In addition, the stop controller 917 includes stop-time power generation control conducted by the stop-time power generation controller 916 in the stop process-1 as necessary. Power generation during stop time denotes power generation for charging the battery 300 in a charging state (State of Charge, which may be referred to as a battery charging rate) to have a predetermined target SOC in preparation for the next activation. In the example of FIG. 3, stop-time power generation is performed from time t1 to time t2.

The stop controller 917 starts filling nitrogen, in the stop process-1 at time t2. For example, the stop controller 917 reduces the opening degree of the sealing valve (Out) 76 to an intermediate opening degree, and then further reduces the opening degree to 0 (zero). The intermediate opening degree denotes an opening degree between a fully open position (the opening degree is 100) and a fully closed position (the opening degree is 0). Consequently, oxygen of the cathode gas in the outlet piping of the fuel cell stack 12 is consumed also after the stop time power generation, and nitrogen is relatively increased.

The stop controller 917 starts the stop process-2 at time t3. The stop controller 917 consumes oxygen, seals air, and inspects the pressure in the vicinity of the electrode structure 24, as the stop process-2. As an example, oxygen remaining in the fuel cell stack 12 is further consumed (oxygen consumption) until time t4 when the sealing valve (In) 74 is fully closed. When the sealing valve (In) 74 is closed at time t4, the cathode gas to be supplied to the fuel cell stack 12 is shut off, and an air-sealed state is obtained.

The stop controller 917 checks the pressure of the anode gas detected by the pressure sensor 93 (pressure inspection) at time t5, and stops the operation of the compressor 68 at time t6. The result of the pressure inspection is used for determining presence or absence of hydrogen and determining completion of the stop.

Accordingly, the series of power generation control ends (device stop) at time t7, and the state shifts to the standby state.

In this manner, the control device 900 conducts the series of power generation control including the activation control based on at least the activation instruction, the normal power generation control based on the power generation target (a target power generation amount instructed from a control unit, not illustrated), and the stop control based on the stop instruction.

### Fluid Flow

### 1. Anode System

The flow of fluid in the anode system 16 in FIG. 1 will be described.

The injector 50 injects the anode gas (hydrogen) of the hydrogen tank 14 toward downstream of the anode supply flow path 40. The anode gas injected from the injector 50 flows through the anode supply flow path 40, and is supplied to the anode flow path 36. The anode gas flows through the anode flow path 36, and is then discharged as an anode off-gas from the anode outlet 17B. The anode off-gas contains hydrogen that has not reacted with oxygen, nitrogen in the cathode gas that has permeated the electrolyte membrane 30, and moisture that has been generated by the reaction between oxygen and hydrogen.

The anode off-gas flows through the anode discharge flow path 42, and is supplied to the gas-liquid separator 54. The gas-liquid separator 54 separates the anode off-gas into a gas component (the anode off-gas) and a liquid component (water). The anode off-gas discharged from the gas-liquid separator 54 flows through the circulation flow path 44, and is supplied to the ejector 52. In the ejector 52, the anode off-gas and the anode gas injected from the injector 50 are combined together.

The water that has been separated by the gas-liquid separator 54 is temporarily stored in the bottom of the gas-liquid separator 54. While the drain valve 56 is open, the water stored in the gas-liquid separator 54 flows through the drain flow path 46, and is discharged to the dilutor 60. While the drain valve 56 is open with no water in the gas-liquid separator 54, the anode off-gas of the gas-liquid separator 54 flows through the drain flow path 46, and is discharged to the dilutor 60.

### 2. Cathode System

The flow of fluid in the cathode system 18 will be described.

The compressor 68 ejects a cathode gas (air) that has been sucked from the outside of the vehicle toward downstream of the cathode supply flow path 62. While the sealing valve (In) 74 is open, the cathode gas that has been discharged from the compressor 68 flows through the cathode supply flow path 62, and is supplied to the cathode flow path 38. The cathode gas flows through the cathode flow path 38, and is discharged as a cathode off-gas from the cathode outlet 19B. The cathode off-gas contains each component contained in air and the moisture that has been generated by the reaction between oxygen and hydrogen.

While the sealing valve (Out) 76 is open, the cathode off-gas flows through the cathode discharge flow path 64, and is discharged to the dilutor 60. The cathode off-gas contains moisture. As described above, it is also possible to use the moisture of the cathode off-gas flowing through the cathode discharge flow path 64 to humidify the cathode gas in the humidifier 70.

While the cathode bypass valve 78 is open, the cathode gas flows through the cathode bypass flow path 66 and the cathode discharge flow path 64, and is discharged to the dilutor 60. By using the cathode bypass flow path 66, it becomes possible to change the supply amount of the cathode gas to the fuel cell stack 12 while adjusting the opening degree of the cathode bypass valve 78 without changing the number of rotations of the compressor 68 (in other words, without changing the total amount of air discharged from the compressor 68).

While the humidifier bypass valve 69 is open, the cathode gas is supplied to the fuel cell stack 12 bypassing the humidifier 70 (in other words, through the humidifier bypass flow path 63). By using the humidifier bypass flow path 63, it becomes possible to supply the cathode gas that is not humidified by the humidifier 70 to the fuel cell stack 12. That is, when dry air is desired to be supplied as the cathode gas in the warm-up power generation, the humidifier bypass valve 69 is opened.

### Forced Valve Opening Processing

The humidifier bypass valve 69 has not been open for a long period of time in some cases depending on the use environment of the fuel cell system 10. As an example, in a case where the fuel cell system 10 is used only in a warm region and does not have to perform the warm-up power generation, there is no opportunity to open the humidifier bypass valve 69 so as to supply dry air to the fuel cell stack 12. For this reason, the humidifier bypass valve 69 has not been open for many years in some cases. Furthermore, in a case where one of the valve seat portion V42 and the valve body V43, which have been described above, is made up of an elastic seal member, the humidifier bypass valve 69 may stick in a valve closed state due to deterioration or the like of the seal member with the lapse of time.

In order to prevent sticking as described above, according to an embodiment, in a case where the humidifier bypass valve 69 is not open in the series of power generation control, forced valve opening processing for the humidifier bypass valve 69 is included in the stop control.

As an example, the stop controller 917 outputs a forced opening and closing instruction signal to the humidifier bypass valve 69 at time t3 in FIG. 3. Specifically, an opening and closing instruction signal is output for fully opening (the opening degree is 100) the humidifier bypass valve 69 in the valve closed state (the opening degree is 0), and then returning to the valve closed state again.

This changes the opening degree of the humidifier bypass valve 69, as indicated by a waveform at the lowermost stage in FIG. 3. By monitoring a temporal change in the opening degree of the humidifier bypass valve 69, based on the opening and closing instruction signal, the stop controller 917 performs spring check and full open learning.

The spring check denotes processing for obtaining a material for determining whether the sealing performance by the humidifier bypass valve 69 can be ensured, and denotes processing for checking whether the time taken from electric conduction off to a predetermined opening degree is equal to or larger than a predetermined value.

In addition, the full open learning denotes processing for equalizing a variation between the gear angle of the butterfly valve itself illustrated in FIGS. 5A and 5B and the mounted position of an opening sensor (not illustrated). This means processing of learning (resetting) the detection position by the opening sensor when the opening degree of the humidifier bypass valve 69 is controlled to be fully closed (an abutment position) to set the control opening to 0 (zero).

### Description of Flowchart

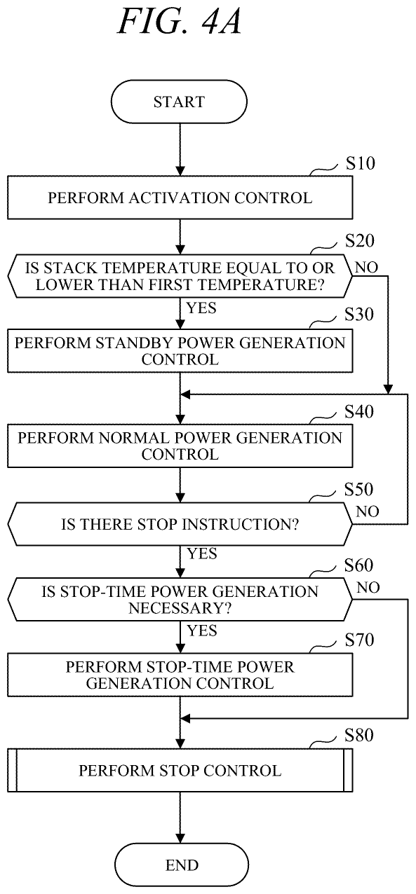

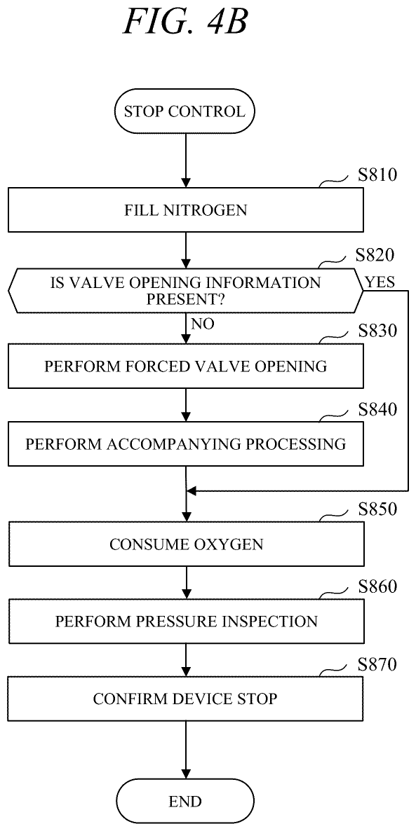

FIGS. 4A and 4B are flowcharts illustrating an example of a series of power generation control processing performed by the controller 911, based on a predetermined program. The controller 911 performs the processing illustrated in FIGS. 4A and 4B when the fuel cell system 10 is turned on (for example, an ignition switch (not illustrated) of the vehicle is turned on).

In step S10 of FIG. 4A, upon receipt of the power generation instruction from a control unit, not illustrated, the controller 911 causes the system activation controller 913 to conduct the activation control on the fuel cell system 10 in the standby state, and processing proceeds to step S20.

In step S20, the controller 911 determines whether the stack temperature is equal to or lower than a first temperature. In a case where the detection signal from the temperature sensor 92 indicates being equal to or lower than the first temperature, the controller 911 makes an affirmative determination in step S20, and the processing proceeds to step S30. In a case where the detection signal is not equal to or lower than the first temperature, the controller 911 makes a negative determination in step S20, and the processing proceeds to step S40. Note that the controller 911 may determine the first temperature, based on the temperature of the cathode off-gas flowing through the cathode discharge flow path 64 or the temperature of the anode off-gas flowing through the anode discharge flow path 42.

In step S30, the controller 911 causes the standby power generation controller 914 to conduct the standby power generation control for causing the fuel cell system 10 to perform the warm-up power generation, and the processing proceeds to step S40.

In step 40, the controller 911 causes the normal power generation controller 915 to conduct the normal power generation control for causing the fuel cell system 10 to perform the normal power generation, and the processing proceeds to step S50.

In step S50, the controller 911 determines whether there is a stop instruction. Upon receipt of the stop instruction from a control unit, not illustrated (corresponding to time t1 in FIG. 3), the controller 911 makes an affirmative determination in step S50, and also starts the stop process-1. Consequently, the stop controller 917 causes the fuel cell system 10 to start the stop process-1, and the processing proceeds to step S60. In a case where the controller 911 does not receive the stop instruction, the controller 911 makes a negative determination in step S50. The processing returns to step S40, and continues the normal power generation control by normal power generation controller 915.

In step S60, the controller 911 determines whether the stop-time power generation is necessary. In a case where the SOC of the battery 300 indicates being equal to or smaller than a target SOC, the controller 911 makes an affirmative determination in step S60, and the processing proceeds to step S70. In a case where the SOC is not equal to or smaller than the target SOC, the controller 911 makes a negative determination in step S60, and the processing proceeds to step S80.

In step S70, the controller 911 causes the stop-time power generation controller 916 to conduct the stop-time power generation control for causing the fuel cell system 10 to perform the stop time power generation, and the processing proceeds to step S80.

In step S80, the controller 911 causes the stop controller 917 to conduct stop control.

Details of the stop control in step S80 will be described with reference to the flowchart in FIG. 4B. In step S810 in FIG. 4B, the stop controller 917 fills nitrogen, and the processing proceeds to step S820 (corresponding to time t2 in FIG. 3).

In step S820, the stop controller 917 determines presence of the valve opening information. In a case where the valve opening information is not stored in the storage 912, the stop controller 917 makes a negative determination in step S820, and the processing proceeds to step S830. In a case where the valve opening information is stored in the storage 912, the stop controller 917 makes an affirmative determination in step S820, and the processing proceeds to step S850.

In step S830, the stop controller 917 outputs a forced opening and closing instruction signal for the humidifier bypass valve 69 at time t3 in FIG. 3 (forced valve opening), and the processing proceeds to step S840 (corresponding to time t3 in FIG. 3).

In step S840, the stop controller 917 performs the spring check and the full open learning as accompanying processing, and the processing proceeds to step S850.

In step S850, the stop controller 917 consumes oxygen as the stop process-2, and the processing proceeds to step S860 (corresponding to time t3 to time t5 in FIG. 3).

In step S860, the stop controller 917 performs the pressure inspection as the stop process-2, and the processing proceeds to step S870 (corresponding to time t5 to time t6 in FIG. 3).

In step S870, the stop controller 917 confirms the device stop, ends the processing of FIG. 4B, and also ends the processing of FIG. 4A (corresponding to time t7 in FIG. 3).

According to the embodiments described above, the following effects are obtained.

(1) The fuel cell system 10 including the fuel cell stack 12, which generates electric power using an anode gas and a cathode gas, and the fuel cell system 10 includes: the control device 900, which conducts a series of power generation control including the activation control (S10) based on at least the activation instruction, the normal power generation control (S40) based on the power generation target, and the stop control (S80) based on the stop instruction; the humidifier bypass valve 69 as a control valve of normally closed type in which the valve body V43, which is movable, and which is in the valve closed state and abuts the seal member of the valve seat portion V42 as the valve seat; and the storage 912 as a storage device for storing valve opening information indicating that the humidifier bypass valve 69 is opened, the humidifier bypass valve 69 being opened under a predetermined condition. The control device 900 determines whether the humidifier bypass valve 69 is opened before the stop control (S80) in the series of power generation control, based on the valve opening information. In a case where the humidifier bypass valve 69 is not opened, the forced valve opening processing (S830) of opening the humidifier bypass valve 69 is included in the stop control (S80).

With such a configuration, in the case where the humidifier bypass valve 69 is not open (in other words, in a case where the valve opening information is not stored in the storage 912) in the series of power generation control, the humidifier bypass valve 69 is opened by the forced valve opening processing (S830) included in the stop control (S80). This enables prevention of the humidifier bypass valve 69 from sticking in the closed state after a long period of time has elapsed while the humidifier bypass valve 69 is not open and the seal member is welded due to the deterioration with the lapse of time.

(2) In the fuel cell system 10 of the above (1), the humidifier bypass valve 69 is provided on the cathode supply flow path 62, which supplies the cathode gas to the fuel cell stack 12, and the control device 900 includes the forced valve opening processing (S830) in the stop control (S80) to perform the forced valve opening processing before or during the oxygen consumption processing (S850) that consumes oxygen remaining in the fuel cell stack 12.

With such a configuration, the humidifier bypass valve 69 is opened by the forced valve opening processing (S830), and even though oxygen flows into the fuel cell stack 12, oxygen in the cathode flow path 38 can be depleted by the oxygen consumption processing (S850), so that deterioration due to the oxygen remaining in the cathode flow path 38 can be prevented.

(3) In the fuel cell system 10 of the above (1) or (2), the control device 900 performs at least one of the spring check processing and the opening degree learning processing of the humidifier bypass valve 69 as accompanying processing in accordance with the forced valve opening processing (S830) (S840).

By performing the spring check processing and the opening degree learning processing of the humidifier bypass valve 69 in accordance with the forced valve opening processing (S830) in this manner, the sealing performance of the cathode supply flow path 62 can be ensured.

(4) The fuel cell system 10 of the above (3) further includes: the humidifier 70, which humidifies the cathode gas; and the humidifier bypass flow path 63, which bypasses the humidifier 70. The humidifier bypass valve 69 is provided on the humidifier bypass flow path 63.

With such a configuration, even in the humidifier bypass valve 69, which is open only in a limited scene of bypassing the humidifier 70, the humidifier bypass valve 69 can be prevented from sticking in the closed state by performing the forced valve opening processing (S830).

(5) In fuel cell system 10 of the above (4), the predetermined condition that the humidifier bypass flow path 63 is opened during the series of power generation control is that the warm-up of the fuel cell system 10 is performed.

With such a configuration, for example, also in the humidifier bypass valve 69, which is open only during the warm-up power generation in the activation at a low temperature, it becomes possible to prevent the humidifier bypass valve 69 from sticking in the valve closed state, by performing the forced valve opening processing (S830) in a case where the valve opening information is not stored in the storage 912 (the warm-up has not been performed).

The above embodiments may be modified into various modes. Hereinafter, modifications will be described.

### First Modification

In the above-described embodiment, the description has been made with regard to an example in which the forced valve opening processing (S830) for the humidifier bypass valve 69 is performed at the start of oxygen consumption in the stop process-2 (time t3 in FIG. 3). Alternatively, the processing may be performed before the start of oxygen consumption in the stop process-2 or during the oxygen consumption processing after the start of oxygen consumption.

### Second Modification

In the above-described embodiment, the description has been made with regard to an example in which the spring check and the full open learning are both performed as the accompanying processing (S840) accompanied with the forced valve opening processing (S830) for the humidifier bypass valve 69. Alternatively, only one of the spring check and the full open learning may be performed as the accompanying processing (S840).

### Third Modification

In the above-described embodiment, the description has been made with regard to an example in which the humidifier bypass valve 69 is configured with a butterfly valve. However, the humidifier bypass valve 69 is not limited to the butterfly valve, and may be configured with any other type of valve.

The above embodiment can be combined as desired with one or more of the above modifications. The modifications can also be combined with one another.

According to the present invention, for example, it becomes possible to prevent the control valve having a limited valve opening scene from sticking in a valve closed state.

Above, while the present invention has been described with reference to the preferred embodiments thereof, it will be understood, by those skilled in the art, that various changes and modifications may be made thereto without departing from the scope of the appended claims.

What is claimed is:

1. A fuel cell system comprising a fuel cell stack configured to generate electric power using an anode gas and a cathode gas, the fuel cell system comprising:
a microprocessor configured to perform a series of power generation control including at least an activation control based on an activation instruction, a normal power generation control based on a power generation target, and a stop control based on a stop instruction;
a memory connected to the microprocessor; and
a normally-closed control valve including a movable valve body abutting, in a valve-closed state, a seal member of a valve seat portion, wherein
the memory stores valve opening information indicating that the control valve has been opened under a predetermined condition, wherein
the microprocessor determines, based on the valve opening information, whether the control valve has been opened before the stop control in the series of power generation control, and wherein
when determining that the control valve has not been opened, the microprocessor performs, in the stop control, a forced valve opening processing for opening the control valve.

2. The fuel cell system according to claim 1, wherein
the control valve is provided on a cathode supply flow path supplying the cathode gas to the fuel cell stack, and wherein
the microprocessor performs the forced valve opening processing before or during oxygen consumption processing configured to consume oxygen remaining in the fuel cell stack.

3. The fuel cell system according to claim 1, wherein
the microprocessor performs, as accompanying processing of the forced valve opening processing, at least one of spring check processing and opening-degree learning processing of the control valve.

4. The fuel cell system according to claim 3, further comprising:
a humidifier configured to humidify the cathode gas; and
a humidifier bypass flow path configured to bypass the humidifier, wherein
the control valve is provided on the humidifier bypass flow path.

5. The fuel cell system according to claim 4, wherein
the predetermined condition for opening the control valve during the series of power generation control is that warm-up of the fuel cell system is performed.
